(19) United States
(12) Patent Application Publication
(10) Pub. No.: US 2004/0055116 A1
(43) Pub. Date: Mar. 25, 2004

(54) Slip proof sleeve for a door knob

(76) Inventor: Li-Chu Chien, Chungho City (JP)

Correspondence Address: VENABLE, BAETJER, HOWARD AND CIVILETTI, LLP, P.O. BOX 34385, WASHINGTON, DC, 20043-9998, US

(21) Appl. No.: 10/251,859

(22) Filed: Sep. 23, 2002

(51) Int. Cl. E05B 1/00

(52) U.S. Cl. 16/441

(57) ABSTRACT

A slip proof sleeve includes a first edge with an undulated pattern, and at least an annular groove defined in an inner face of the slip proof sleeve. With the at least one annular groove, the slip proof sleeve is able to fit to and completely engage with an outer contour of a door knob.

### BACKGROUND OF THE INVENTION

1. Field of the Invention

The present invention relates to a slip proof sleeve for a door knob, and more particularly to a sleeve that has at least one annular recess defined in an inner face of the sleeve so that the sleeve is able to enclose a contour of the door knob to provide a slip proof effect to the user.

2. Description of Related Art

A door knob generally is conical or polygonal is shape. When a user tries to rotate the door knob in a rainy day, the user may encounter difficulties trying to rotate the door knob because door knob is slippery due to the humidity in the air. Sometimes, when the user's hand is oily or greasy, the user still has problem trying to properly rotate the door knob.

Furthermore, during dry and cold winter days, static often causes a shock to the people who are trying to open a door or grab an object, which is quite annoying though it is harmless.

To overcome the shortcomings, the present invention tends to provide an improved slip proof sleeve for a door knob to mitigate and obviate the aforementioned problems.

### SUMMARY OF THE INVENTION

The primary objective of the present invention is to provide an improved slip proof sleeve for a door knob. The sleeve is made of a resilient material and has at least one annular recess defined in an inner face of the sleeve such that when the sleeve is mounted around the door knob, the sleeve is able to securely engage with a contour of the door knob.

In order to accomplish the foregoing objective, the slip proof sleeve that is made of a resilient material has an undulated edge and a smooth edge relative to the undulated edge. At least one annular recess is defined in an inner face of the sleeve so that after the sleeve is mounted around the door knob, the sleeve is able to securely engage with a contour of the door knob.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the slip proof sleeve of the present invention;

FIG. 2 is a cross sectional view of the slip proof sleeve in FIG. 1;

FIG. 3 is a schematic view of the slip proof adapted to be mounted on a door knob;

FIG. 4 is a cross sectional view of a second preferred embodiment of the slip proof sleeve of the present invention; and

FIG. 5 is an end view showing that the second embodiment of the slip proof sleeve is adapted to be mounted on a polygonal door knob.

### DETAILED DESCRIPTION OF THE PREFERRED EMBODIMENT

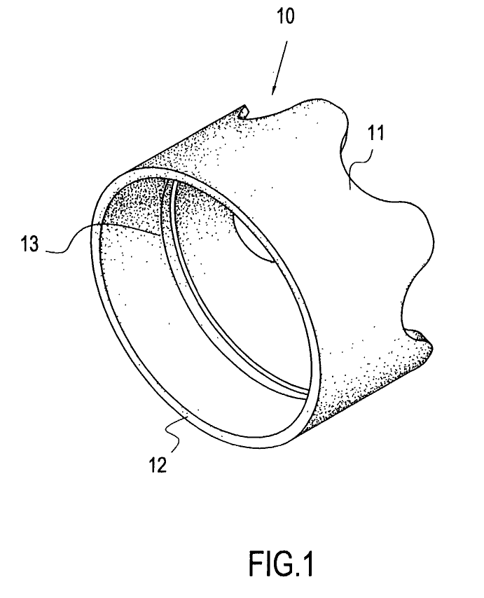

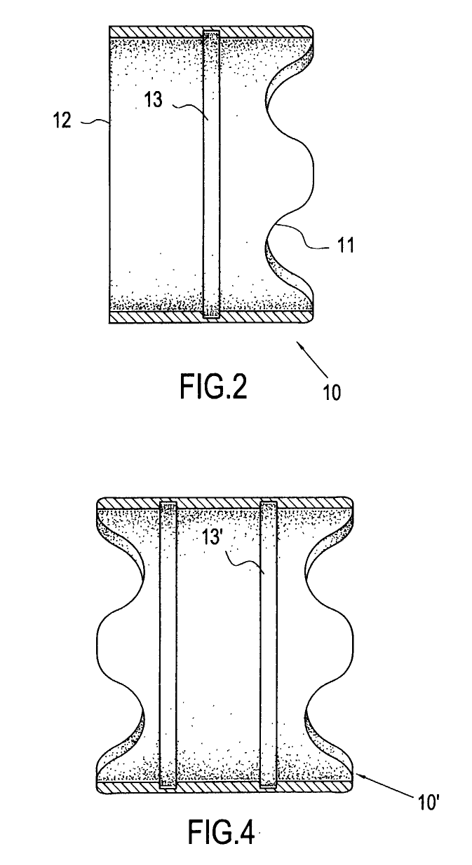

With reference to FIGS. 1 and 2, the slip proof sleeve (10) in accordance with the present invention is a hollow cylinder and has a first edge with an undulated pattern (11) and a flat second edge (12). An annular groove (13) is annularly defined in the sleeve (10) between the first edge and the second edge.

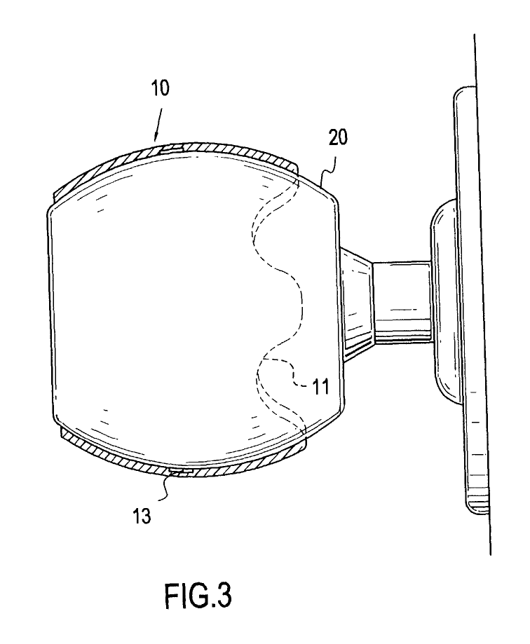

With reference to FIG. 3, the sleeve (13) is provided to adapt to a normally conical door knob (20). It is noted that with the annular groove (13), the sleeve (10) is able to completely fit to and engage with an outer contour of the conical door knob (20).

With reference to FIG. 4, it is to be noted that the slip proof sleeve (10′) of the present invention has both edges with undulated pattern to increase the attraction of the slip proof sleeve (10′) and two annular grooves (13′) defined in an inner face of the sleeve (13′).

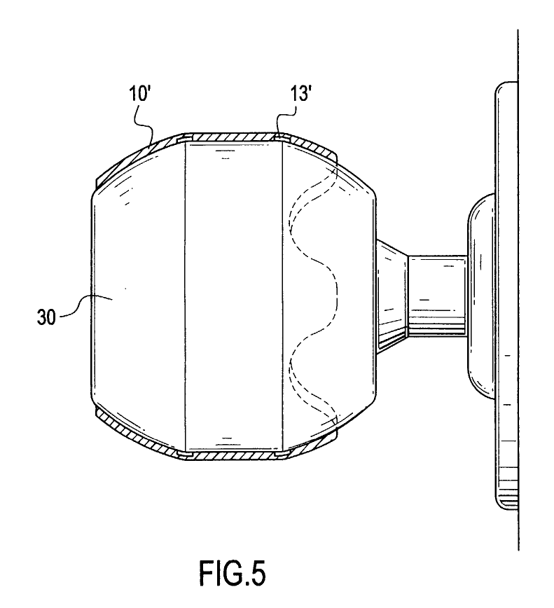

With reference to FIG. 5, when a polygonal door knob (30) is applied, because of the two annular grooves (13′) defined in the inner face of the sleeve (10′), the sleeve (13′) of the present invention is able to fit to and completely engage with an outer contour of the polygonal door knob (30).

From the foregoing description, it is noted that no matter what shape of the door knob is, the sleeve of the present invention is able to complete adapt to the outer contour of the door knob so as to provide a slit proof effect and a static free protection to the user in especially cold and dry days.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A slip proof sleeve comprising:
a first edge with an undulated pattern; and
at least an annular groove defined in an inner face of the slip proof sleeve so that the slip proof sleeve is able to fit to and completely engage with an outer contour of a door knob to provide a slip proof effect and static free protection.

2. The slip proof sleeve as claimed in claim 1 further comprising a second edge with an undulated pattern.

3. The slip proof sleeve as claimed in claim in claim 2, wherein there are two annular grooves defined in the inner face of the slip proof sleeve.
